(19) United States
(12) Patent Application Publication
(10) Pub. No.: US 2007/0012426 A1
(43) Pub. Date: Jan. 18, 2007

(54) High efficiency high turbulence heat exchanger

(75) Inventor: Giuseppe Rago, Mississagi (CA)

Correspondence Address: OGILVY RENAULT LLP (PWC), 1981 MCGILL COLLEGE AVENUE, SUITE 1600, MONTREAL, QC, H3A 2Y3, CA

(73) Assignee: Pratt & Whitney Canada Corp.

(21) Appl. No.: 11/180,640

(22) Filed: Jul. 14, 2005

(51) Int. Cl. B01F 15/06

(52) U.S. Cl. 165/92; 165/154

(57) ABSTRACT

A heat exchange device comprises a housing defining first and second fluid passages therein separated by an interface therebetween, for directing first and second fluids therethrough, respectively, a means for creating turbulence in the second fluid while passing through the second fluid passage, and a means integrated with the interface for increasing heat transfer surface areas for both the first and second fluids, thereby increasing heat transfer efficiency therebetween.

### TECHNICAL FIELD

The invention relates generally to heat transfer equipment and, more particularly, to a high efficiency high turbulence heat exchanger suitable for aircraft gas turbine engines to cool the fluids circulated in the engines.

In an aircraft turbine engine it is always a challenge to manage the heat generated by the engine bearings and gear boxes. Oil is generally used to lubricate and cool the bearings of the main shafts of the engine and the gears in the gearbox. In the oil circulation system of aircraft turbine engines, used oil which has picked up heat must be cooled, cleaned and re-circulated. Cooling of the oil is accomplished by transferring the heat from the oil to two mediums available, those being air or feel. A fuel/oil heat exchanger is preferable because it is light in weight, small in size and inexpensive to manufacture. Furthermore, a fuel/oil heat exchanger retains and reuses the heat in the engine to minimize engine performance loss because the heat from the oil is put back into the engine cycle via the fuel to be burned in the combustor. Theories and concepts of means for transferring differences of temperature between various mediums or bodies of fluids are generally well known. In the past, attempts have been made to increase the coefficient of heat transfer between two surfaces having a fluid in contact therewith, by means of: increasing the heat transfer area of contact between surfaces having a difference in temperature gradient, increasing the flow rate between the heat transfer surfaces, etc.

Nevertheless, there is still a need to apply those theories and concepts in practice by configuring a high efficiency high turbulence heat exchanger which is relatively simple in structure to manufacture and suitable for an aircraft turbine engine.

### SUMMARY OF THE INVENTION

It is therefore an object of the present invention to provide a high efficiency high turbulence heat exchanger.

In one aspect, the present invention provides a heat exchange device which comprises a housing defining first and second fluid passages therein separated by an interface therebetween, for directing first and second fluids therethrough, respectively. A means is provided for creating turbulence in the second fluid while passing through the second fluid passage. There is also a means integrated with the interface for increasing heat transfer surface areas for both the first and second fluids, thereby increasing heat transfer efficiency therebetween.

In another aspect, the present invention provides a heat exchange device which comprises outer and inner stationary cylinders disposed co-axially around a rotor, in combination defining an outer annular chamber between the outer and inner cylinders for directing a first fluid therethrough and an inner annular chamber between the inner cylinder and the rotor for directing a second fluid therethrough. The inner cylinder includes a plurality of heat transfer contact elements on both outer and inner surfaces thereof, extending into the respective outer and inner chambers to increase heat transfer surface areas for the respective first and second fluids. The rotor is rotated to create turbulence in the second fluid to facilitate heat transfer between the first and second fluids.

In a further aspect, the present invention provides a method for improving heat exchange efficiency between first and second fluids, the first fluid having a lower viscosity relative to the second fluid. The method comprises directing the first and second fluids in opposite directions through first and second fluid passages separated by an interface therebetween; increasing heat transfer surface areas to the first and second fluids by using heat transfer elements on both sides of the interface extending into the respective passages; and increasing a velocity of at least one of the fluids while the fluid passes through a corresponding fluid passage.

Further details of these and other aspects of the present invention will be apparent from the detailed description and figures included below.

### DESCRIPTION OF THE DRAWINGS

Reference is now made to the accompanying figures depicting aspects of the present invention, in which:

FIG. 1 is a longitudinal cross-sectional view of a heat exchange device according to one embodiment of the present invention;

FIG. 2 is a cross-sectional view taken along line 2-2 of FIG. 1;

FIG. 3 is a longitudinal cross-sectional view of a heat exchange device in accordance with another embodiment of the second invention; and

FIG. 4 is a cross-sectional view of the heat exchange device taken along line 4-4 in FIG. 3.

### DETAILED DESCRIPTION OF THE PREFERRED EMBODIMENTS

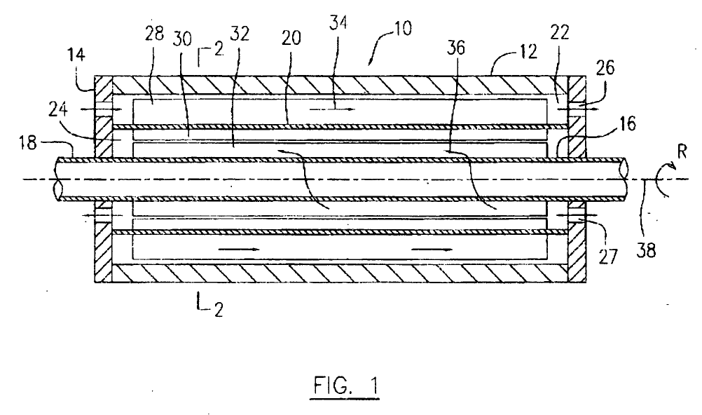

FIGS. 1 and 2 illustrate a heat exchange device generally indicated by numeral 10, in accordance with one embodiment of the present invention, which, as an example of the present invention, is suitable for aircraft turbine engines as a fuel/oil heat exchanger to transfer heat from the oil to the liquid fuel to be burned in the combustor of the gas turbine engine. The heat exchanger device 10 includes a housing or an outer cylinder 12 having two end covers 14 detachably attached to the opposite ends thereof, for example, by mounting screws (not shown). Annular seals (not shown) are preferably provided between the ends of the outer cylinder 12 and the end covers 14 to prevent fluid leakages therebetween. A rotor 16 is disposed coaxially within the outer cylinder 12 and is operatively supported by the end covers 14 which have central openings (not indicated) to allow a rotatable shaft 18 of the rotor 16 to extend axially therethrough. The rotatable shaft 18 can be either a solid or hollow shaft, and at least one end thereof (although two ends thereof are shown) extends axially and outwardly from the end cover 14 to be adapted to couple with a driving mechanism (not shown) to drive the rotor 16 in a rotation as indicated by arrow R. Annular seals (not shown) are provided between the rotatable shaft 18 and the respective end covers 14 in order to prevent fluid leakage therebetween when the rotor 16 is rotated.

An inner cylinder 20 is disposed within the outer cylinder 12 and coaxially around the rotor 16. The inner cylinder 20 is detachably attached to and supported by the respective end covers 14. For example, each of the end covers 14 may have an axial flange (not shown) protruding from an inner side thereof for centrally positioning and supporting the inner cylinder 20 within the outer cylinder 12. Annular seals (not shown) are also provided between the opposite ends of the inner cylinder 20 and the respective end covers 14, to prevent fluid leakage therefrom. Thus, an outer annular chamber 22 is defined between the outer cylinder 12 and the inner cylinder 20, and an inner chamber 24 is defined between the inner cylinder 20 and the rotor 16.

Each of the end covers 14 includes one or more (only one shown) openings 26 in fluid communication with the outer chamber 22, and one or more (only one shown) openings 27 in fluid communication with the inner chamber 24. The respective openings 26, 27 at the opposite ends of the heat exchange device 10 are adapted to be connected in two fluid circulation systems such that the housing or the outer cylinder 12 defines two fluid passages (not indicated) separated by the inner cylinder which functions as an interface between the two fluid passages. When two fluids having temperature differences are directed through the two fluid passages, respectively, and preferably in opposite directions, the inner cylinder 20 as the interface between the two fluid flows contacts on the outer surface thereof one fluid flow and on the inner surface thereof the other fluid flow, thereby conducting a heat transfer from the fluid having a higher temperature to the fluid having a lower temperature.

In accordance with the present invention, the inner cylinder 20 as an interface between the two fluid passages, further includes a means integrated therewith for increasing heat transfer surface areas for both fluid flows, thereby increasing heat transfer efficiency therebetween. Preferably, the inner cylinder includes a plurality of heat transfer contact elements on both outer and inner surfaces thereof extending into the respective outer and inner chambers 22, 24. In this embodiment, a plurality of outer fins 28 circumferentially spaced apart one from another, extend radially and outwardly from the outer surface of the inner cylinder 20. The outer fins 28 extend preferably over a substantial axial length of the inner cylinder 20, with an axial space between the ends thereof and the respective end covers 14. The outer fins 28 have a radial dimension preferably slightly smaller than the radial dimension of the outer annular chamber 22 such Hat the inner cylinder 20 with the integrated outer fins 28 can be conveniently inserted from one end into the outer cylinder 12 when one of the end covers 14 is removed, and can also provide a maximum field transfer surface area for the fluid flowing through the outer chamber 22. The inner cylinder 20 further preferably includes a plurality of inner fins 30 circumferentially spaced apart one from another, extending radially and inwardly from the inner surface of the inner cylinder 20 into the inner chamber 24. The inner fins 30 have an axial length preferably similar to the axial length of the outer fins 29. Nevertheless, the radial dimension of the inner fins 30 is preferably a fraction of the radial dimension of the inner chamber 24, for example 30% to 50% thereof.

The integrated inner cylinder 20 with the outer and inner fins 28, 30 are made of heat conductive material, for example, iron or steel.

Heat transfer efficiency relies not only on the heat transfer surface areas but also on the velocity and the viscosity of the two fluids, the specific heat capacity and the ability to cause turbulence in the two fluid flows in order to promote high heat transfer. A high “Reynolds” number (RE) raises the heat transfer coefficient. The RE is a function of fluid velocity, fluid viscosity and the hydraulic diameter of the passage, which can be expressed as follows:
RE=V×Dh/v
wherein V is velocity, Dh is hydraulic diameter and v is viscosity.

Nevertheless, the viscosity of the fluids, for example, the liquid fuel and the oil used in gas turbine engines, are casually predetermined parameters and are not selectable by the heat exchanger designer. The hydraulic diameter of the fluid passages are also limited by the size of the heat exchanger, particularly when the heat exchanger is designed to be used for aircraft gas turbine engines. The outer and inner fins 28, 30 in this embodiment increase the available surface contacted by the fluids. The fin arrangements also cause turbulence of the liquid and/or mixing of portions of the fluid having temperature gradients in the respective outer and inner annular chambers 22, 24, which also improves heat transfer. In a fuel/oil heat exchanger application, the oil side controls the heat transfer because the viscosity of the oil is significantly higher than the viscosity of liquid fuel. This results in a significantly lower RE number at the oil side with respect to that of the fuel side, and thus decreases the capacity for heat transfer from the oil to the fuel. In accordance with this embodiment of the present invention, a means for creating turbulence in, and increasing the velocity of the oil, such as the rotor 16, is provided within the inner cylinder 20, in order to improve the RE number at the oil side.

The rotor 16 preferably includes a plurality of blades 32 circumferentially spaced apart one from another and extending radially and outwardly from the rotatable shaft 18. Blades 32 extend preferably over an axial length of the rotatable shaft 18, similar in length to the axial length of the outer and inner fins 28, 30. The blades 32 are optionally oriented at a small angle with respect to an axial axis 38 of the rotatable shaft 18, thereby presenting a slightly spiral shape (not shown) in order to move the liquid such as oil, in both circumferential and axial directions when the fluid flow passes through the inner chamber 24. The tip edges of the blades 32 define an outer diameter of the rotor 16 which is preferably slightly smaller than an inner diameter of the inner cylinder 20 defined by the tip edges of the inner fins 30 thereof, in order to prevent interference between the blades 32 and the inner fins 30 when the rotor 16 rotates.

This embodiment of the present invention advantageously has a simple configuration in which the inner cylinder 20 with the outer and inner fins 28, 30 and the rotor 16 can be conveniently manufactured, for example by cast and then machining, and can then to be put together without further brazing or welding. The assembly is quite simple. The completed inner cylinder 20 and the rotor 16 are slid into the outer cylinder 12 from one end thereof, and the end covers 14 are then attached to the opposite ends of the outer cylinder 12 to position the inner cylinder 20 and the rotor 16 coaxially within the outer cylinder 12.

In use, a first fluid such as liquid fuel is directed through the outer annular chamber 22 via the openings 26 in opposite ends of the heat exchange device 10, in a direction indicated by arrows 34. A second fluid such as hot oil is directed through the inner chamber 24 via the openings 27 in opposite ends of the heat exchange device 10, in a direction indicated by arrows 36. The fuel and oil are directed preferably in opposite directions through the heat exchange device 10. The rotor 16 is rotated and the blades 32 thereof increase the velocity of the oil flow and create turbulence in the oil flow when the oil flow passes through the inner chamber 24. The hot oil and liquid fuel contact not only the respective inner and outer surfaces of the inner cylinder 20, but also the inner and outer fins 30, 28 which are integrated with the inner cylinder 20. Thus, the heat transfer surface areas are significantly increased in contrast to outer and inner annular chambers separated by an annular interface without fins. The outer and inner fins 28, 30 also disturb the respective fuel and hot oil flow, thereby creating turbulence thereof. The inner fins 30 are more effective for creating turbulence because the oil flow through the inner chamber 24 includes more circumferential components. Additionally, the rotor 16 optionally functions as an axial rotary pump creating the oil flow pressure in compensation for the pressure loss over the length of the heat exchange device 10 when the blades 32 are oriented at a small angle with respect to the axial axis 38 of the rotatable shaft 18.

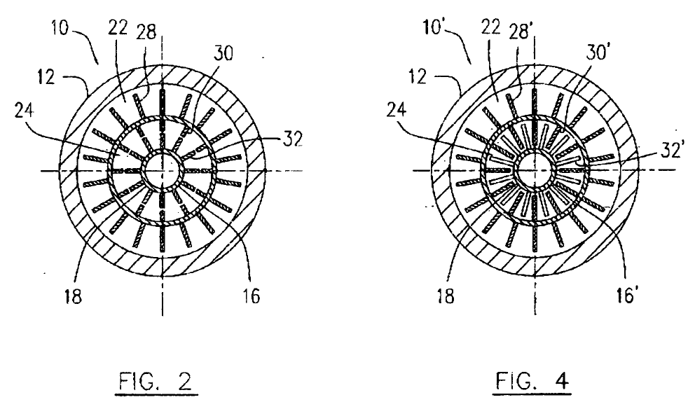

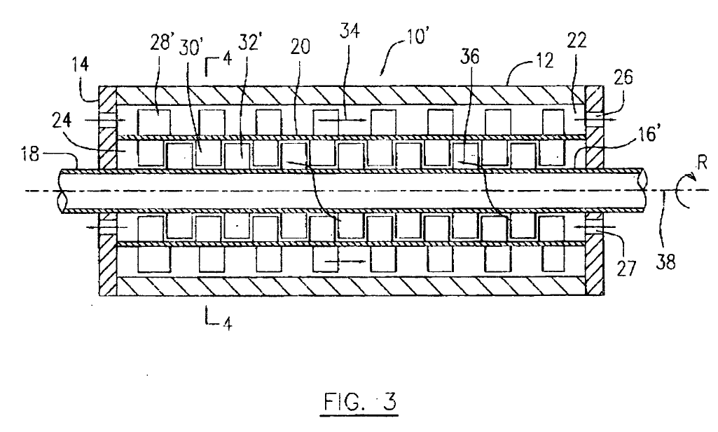

FIGS. 3 and 4 illustrate another embodiment of the present invention in which the heat exchange device 10′ is similar to the heat exchange device 10 of FIGS. 1 and 2. Similar components and features indicated by similar numerals in the two embodiments are not repeated in the description of the heat exchange device 10′. In contrast to the heat exchange device 10 of FIGS. 1 and 2, the inner cylinder 20 of the heat exchange device 10′ has a plurality of outer and inner fins 23′, 30′ divided into axial groups which are axially spaced apart one from another. Similarly, the rotor 16′ has a plurality of blades 32′ divided into axial groups which are axially spaced apart one from another. The axial groups of the blades 32′ are disposed alternately in the axial direction with respect to the axial groups of the inner fins 30′, thereby avoiding interference therebetween during rotation of the rotor 16′. In such an arrangement, the radial dimension of both inner fins 30′ and blades 32′ can significantly increase in contrast to the respective inner fins 30 and blades 32 of heat exchange device 10 of FIGS. 1 and 2. Preferably, the outer diameter of the rotor 16′ defined by the tip edges of the blades 32′ is greater than the inner diameter of the inner cylinders 20 defined by the tip edges of the inner fins 30′, and is preferably slightly smaller than a diameter of the inner surface of the inner cylinder 20. The blades 32′ act as axial rotary pump blades when oriented at a small angle relative to the axis 38 of the rotatable shaft 18. The inner fins 30′ act as stationary vanes which more effectively create turbulence in the oil flow passing through the inner annular chamber 24.

Alternatively, the outer fins 28′ can be made similar to the outer fins 28 of the heat exchange device 10 of FIGS. 1 and 2, extending continuously in the axial length without being divided into axial groups.

It should be noted that the number of the respective outer fins 28, inner fins 30 and blades 32 of the heat exchange device 10 of FIGS. 1 and 2 can be selected equally or differently. However, the number of the respective inner fins 30′ and blades 32′ of FIGS. 3 and 4, is preferably equal such that when the heat exchange device 10′ is being assembled, the blades 32′ can be circumferentially aligned with the spaces between adjacent inner fins 30′ in order to be slipped between the adjacent inner fins 30′. When each blade 32′ is optionally, slightly angled with respect to the axis 38 of the rotatable shaft 18, the blades 32′ of one axial group are preferably circumferentially aligned with the respective blades 32′ in other axial groups for convenience of assembly.

The above description is meant to be exemplary only, and one skilled in the art will recognize that changes may be made to the embodiments described without departure from the scope of the invention disclosed. The inventive concept of heat exchange devices as disclosed herein may function either as a separate heat exchanger or as a component of a system to be used in various applications other than a fuel/oil heat exchanger. Modifications which fall within the scope of the present invention will be apparent to those skilled in the art, in light of a review of this disclosure, and such modifications are intended to fall within the appended claims.

1. A heat exchange device comprising a housing defining first and second fluid passages therein separated by an interface therebetween, for directing first and second fluids therethrough, respectively, a means for creating turbulence in the second fluid while passing through the second fluid passage, and a means integrated with the interface for increasing heat transfer surface areas for both the first and second fluids, thereby increasing heat transfer efficiency therebetween.

2. The heat exchange device as claimed in claim 1 wherein the means for creating turbulence comprises an axial rotary pump rotor operatively supported within the second fluid passage.

3. The heat exchange device as claimed in claim 2 wherein the axial rotary pump rotor comprises a rotatable shaft having a plurality of blades extending radially and outwardly therefrom for moving the second fluid circumferentially around the axial rotary pump rotor and axially through the second fluid passage.

4. The heat exchange device as claimed in claim 1 wherein the means for increasing heat transfer with both the first and second fluids comprises a first group of heat transfer contact elements protruding from a first side of the interface into the first fluid passage and a second group of heat transfer contact elements protruding from a second side of the interface into the second fluid passage.

5. A heat exchange device comprising outer and inner stationary cylinders disposed co-axially around a rotor, in combination defining an outer annular chamber between the outer and inner cylinders for directing a first fluid therethrough and an inner annular chamber between the inner cylinder and the rotor for directing a second fluid therethrough, the inner cylinder including a plurality of heat transfer contact elements on both outer and inner surfaces thereof extending into the respective outer and inner chambers to increase heat transfer surface areas for the respective first and second fluids, and the rotor being rotated to create turbulence in the second fluid in order to facilitate heat transfer between the first and second fluids.

6. The heat exchange device as claimed in claim 5 wherein the inner cylinder comprises a plurality of outer fins circumferentially spaced apart one from another, extending radially and outwardly from the outer surface of the inner cylinder such that the first fluid flowing through the outer annular chamber is in contact with the outer surface of the inner cylinder and the outer fins.

7. The heat exchange device as claimed in claim 5 wherein the inner cylinder comprises a plurality of inner fins circumferentially spaced apart one from another, extending radially and inwardly from the inner surface of the inner cylinder such that the second fluid flowing through the inner annular chamber is in contact with the inner surface of the inner cylinder and the inner fins.

8. The heat exchange device as claimed in, claim 7 wherein the rotor comprises a plurality of blades circumferentially spaced apart one from another and extending radially and outwardly from the rotor.

9. The heat exchange device as claimed in claim 8 wherein an outer diameter of the rotor defined by tip edges of the blades is smaller than an inner diameter of the inner cylinder defined by tip edges of the inner fins, the rotor thereby rotating without interference with the inner fins of the inner cylinder.

10. The heat exchange device as claimed in claim 8 wherein the blades of the rotor and the inner fins of the inner cylinder are divided into axial groups, the axial groups of the blades being disposed alternately with respect to the axial groups of the inner fins, thereby to avoid interference therebetween during rotation of the rotor.

11. The heat exchange device as claimed in claim 10 wherein an outer diameter of the rotor defined by tip edges of the blades is greater than an inner diameter of the inner cylinder defined by tip edges of the inner fins, and smaller than a diameter of the inner source of the inner cylinder.

12. The heat exchange device as claimed in claim 8 wherein each of the blades is oriented in an angle with respect to an axial axis of the rotor, thereby moving the second fluid axially and circumferentially through the inner annular chamber.

13. The heat exchange device as claimed in claim 5 comprising end covers attached to respective opposite ends of the both outer and inner cylinders, the end covers operatively supporting the rotor within the inner cylinder.

14. A method for improving heat exchange efficiency between first and second fluids, the first fluid having a lower viscosity relative to the second fluid, comprising:
directing the first and second fluids in opposite directions through first and second fluid passages separated by an interface therebetween;
increasing heat transfer surface areas for the first and second fluids by using heat transfer elements on both sides of the interface extending into the respective passages; and
increasing a velocity of at least one of the fluids while passing through a corresponding fluid passage.

15. The method as claimed in claim 14 wherein the velocity increasing step is practised by increasing the velocity of the second fluid.

16. The method as claimed in claim 15 wherein the velocity increasing step is further practiced by using an axial rotary pump incorporated in the second fluid passage, thereby increasing the velocities in both axial and circumferential directions.
